(19) United States
(12) Patent Application Publication
(10) Pub. No.: US 2021/0192465 A1
(43) Pub. Date: Jun. 24, 2021

(54) CALENDAR OVERLAP RESOLUTION

(71) Applicant: Lenovo (Singapore) Pte. Ltd., Singapore (SG)

(72) Inventors: Russell Speight VanBlon, Raleigh, NC (US); Jonathan Co Lee, Cary, NC (US); Philip L. Childs, Fort Wayne, IN (US)

(21) Appl. No.: 16/724,727

(22) Filed: Dec. 23, 2019

(51) Int. Cl. G06Q 10/10

(52) U.S. Cl. CPC G06Q 10/1095

(57) ABSTRACT

One embodiment provides a method, including: identifying, using a processor, a user as a receiver of an event request; receiving, at an information handling device, an acceptance indication of the event request from the user; determining, using a processor, whether an overlap exists between an event associated with the accepted event request and at least one other event; and performing, responsive to determining that the overlap exists, an action to resolve a conflict created by the overlap. Other aspects are described and claimed.

### BACKGROUND

Individuals receive a variety of communications each day on their information handling devices (“devices”), for example laptop and/or personal computers, smart phones, tablet devices, hybrid devices, and the like. These communications may include requests that invite the individual to attend an in-person or virtual meeting or event. Responsive to accepting the invitation, the occasion may be reflected on a calendar associated with the individual.

### BRIEF SUMMARY

In summary, one aspect provides a method, comprising: identifying, using a processor, a user as a receiver of an event request; receiving, at an information handling device, an acceptance indication of the event request from the user; determining, using a processor, whether an overlap exists between an event associated with the accepted event request and at least one other event; and performing, responsive to determining that the overlap exists, an action to resolve a conflict created by the overlap.

Another aspect provides a method, comprising: identifying, using a processor, a user as an organizer of an event request; identifying an overlap resolution parameter associated with the event request; receiving, at an information handling device, a command to transmit the event request to at least one other individual; receiving an indication that an overlap exists for the at least one individual between an event associated with the event request and at least one other event; and resolving, with reference to the overlap resolution parameter, the overlap.

A further aspect provides an information handling device, comprising: a processor; a memory device that stores instructions executable by the processor to: identify a user as a receiver of an event request; receive an acceptance indication of the event request from the user; determine whether an overlap exists between an event associated with the accepted event request and at least one other event; and perform, responsive to determining that the overlap exists, an action to resolve a conflict created by the overlap.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of information handling device circuitry.

FIG. 3 illustrates an example method of resolving event request overlaps from a recipient's perspective.

FIG. 4 illustrates an example method of resolving event request overlaps from an organizer's perspective.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

When an event invitation is accepted by an individual, details associated with the accepted event may be reflected on an individual's virtual calendar. More particularly, a time slot during which the event is scheduled to occur may be visually distinguished to the individual and/or additional details associated with the event may be readily available (e.g., event location, event attendees, etc.). These conventional scheduling techniques make it convenient for a user to receive, accept, and display various events.

Conventional systems may allow individuals to accept any and all event invitations, regardless of whether a conflict, or time overlap, exists between two or more events. It stems to reason that an increased number of event invitations increases the likelihood that such conflicts may occur. When conflicts are not resolved in a timely manner, issues may arise for the individual, the event organizer, or others. As an example, a user may accept multiple event invitations of varying priority, some of which may overlap. When the user does not notify the remaining attendees that they will not attend an event, the remaining attendees are left to wonder if the user chose to attend another meeting, forgot about their meeting, or just chose not to show up. Such a result may not only reflect poorly on the user but may also prevent the remaining attendees from efficiently accomplishing a particular task.

Existing solutions are lacking with respect to calendaring conflict resolution. For example, current systems may provide a notification to a user that a conflict exists but may nevertheless allow the user to maintain the conflict (e.g., by allowing the user to accept a conflicting event request or by allowing a user to add a conflicting item to their “To do” list, etc.). As another example, a user may manually notify an event organizer of their potential absence, but oftentimes users forget to do this. In yet another example, a user may mark their attendance as “tentative” for meetings that partially overlap (i.e., meetings that a user can only attend a portion of). However, this “tentative” designation applies to the entire meeting, rather than just the portion in question.

Accordingly, an embodiment provides a method for dynamically and automatically resolving calendaring conflicts for both event receivers and event organizers. In an embodiment, a user may be identified as a receiver of an event request. Responsive to receiving an acceptance indication of the event request, an embodiment may determine whether an overlap exists between an event associated with the accepted event request and at least one other event. Responsive to determining that an overlap exists, an embodiment may perform one or more actions to resolve a conflict resulting from the overlap. Such a method may ensure that overlaps on the receiver end do not go unaddressed.

In another embodiment, a user may be identified as an organizer of an event request and an embodiment may identify an overlap resolution parameter associated with the event request. The overlap resolution parameter may be associated with a remedial measure, occurring prior to or after transmission of an event request, that may minimize the impact of an event overlap. In an embodiment, a command to transmit the event request to one or more other individuals may be received. If an embodiment thereafter receives an indication that an overlap exists for one of the event recipients, an embodiment may resolve the overlap with reference to the overlap resolution parameter. Such a method may provide an organizer of an event with a more accurate potential attendance indication for their event.

The illustrated example embodiments will be best understood by reference to the figures. The following description is intended only by way of example, and simply illustrates certain example embodiments.

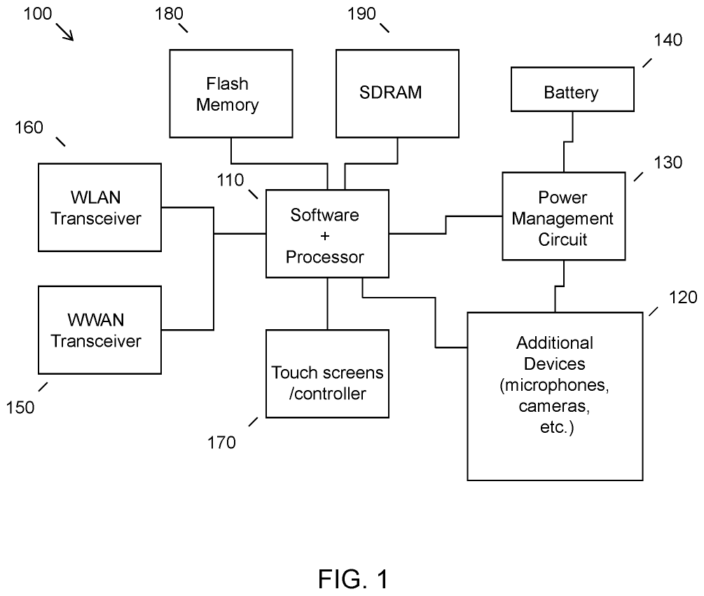

While various other circuits, circuitry or components may be utilized in information handling devices, with regard to smart phone and/or tablet circuitry 100, an example illustrated in FIG. 1 includes a system on a chip design found for example in tablet or other mobile computing platforms. Software and processor(s) are combined in a single chip 110. Processors comprise internal arithmetic units, registers, cache memory, busses, I/O ports, etc., as is well known in the art. Internal busses and the like depend on different vendors, but essentially all the peripheral devices (120) may attach to a single chip 110. The circuitry 100 combines the processor, memory control, and I/O controller hub all into a single chip 110. Also, systems 100 of this type do not typically use SATA or PCI or LPC. Common interfaces, for example, include SDIO and I2C.

There are power management chip(s) 130, e.g., a battery management unit, BMU, which manage power as supplied, for example, via a rechargeable battery 140, which may be recharged by a connection to a power source (not shown). In at least one design, a single chip, such as 110, is used to supply BIOS like functionality and DRAM memory.

System 100 typically includes one or more of a WWAN transceiver 150 and a WLAN transceiver 160 for connecting to various networks, such as telecommunications networks and wireless Internet devices, e.g., access points. Additionally, devices 120 are commonly included, e.g., an image sensor such as a camera, audio capture device such as a microphone, etc. System 100 often includes one or more touch screens 170 for data input and display/rendering. System 100 also typically includes various memory devices, for example flash memory 180 and SDRAM 190.

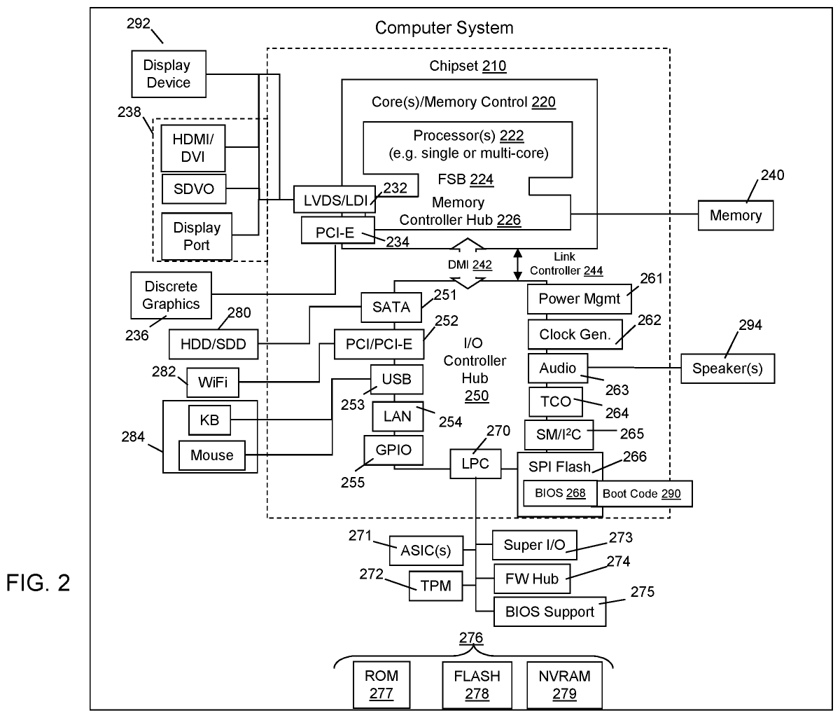

FIG. 2 depicts a block diagram of another example of information handling device circuits, circuitry or components. The example depicted in FIG. 2 may correspond to computing systems such as the THINKPAD series of personal computers sold by Lenovo (US) Inc. of Morrisville, N.C., or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer (for example, INTEL, AMD, ARM, etc.). INTEL is a registered trademark of Intel Corporation in the United States and other countries. AMD is a registered trademark of Advanced Micro Devices, Inc. in the United States and other countries. ARM is an unregistered trademark of ARM Holdings plc in the United States and other countries. The architecture of the chipset 210 includes a core and memory control group 220 and an I/O controller hub 250 that exchanges information (for example, data, signals, commands, etc.) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture. One or more processors 222 comprise internal arithmetic units, registers, cache memory, busses, I/O ports, etc., as is well known in the art.

In FIG. 2, the memory controller hub 226 interfaces with memory 240 (for example, to provide support for a type of RAM that may be referred to as “system memory” or “memory”). The memory controller hub 226 further includes a low voltage differential signaling (LVDS) interface 232 for a display device 292 (for example, a CRT, a flat panel, touch screen, etc.). A block 238 includes some technologies that may be supported via the LVDS interface 232 (for example, serial digital video, HDMI/DVI, display port). The memory controller hub 226 also includes a PCI-express interface (PCI-E) 234 that may support discrete graphics 236.

In FIG. 2, the I/O hub controller 250 includes a SATA interface 251 (for example, for HDDs, SDDs, etc., 280), a PCI-E interface 252 (for example, for wireless connections 282), a USB interface 253 (for example, for devices 284 such as a digitizer, keyboard, mice, cameras, phones, microphones, storage, other connected devices, etc.), a network interface 254 (for example, LAN), a GPIO interface 255, a LPC interface 270 (for ASICs 271, a TPM 272, a super I/O 273, a firmware hub 274, BIOS support 275 as well as various types of memory 276 such as ROM 277, Flash 278, and NVRAM 279), a power management interface 261, a clock generator interface 262, an audio interface 263 (for example, for speakers 294), a TCO interface 264, a system management bus interface 265, and SPI Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Information handling device circuitry, as for example outlined in FIG. 1 or FIG. 2, may be used in devices capable of supporting one or more calendaring applications and capable of receiving and processing event requests directed to those calendaring applications. For example, the circuitry outlined in FIG. 1 may be implemented in a smart phone or tablet embodiment, whereas the circuitry outlined in FIG. 2 may be implemented in a laptop.

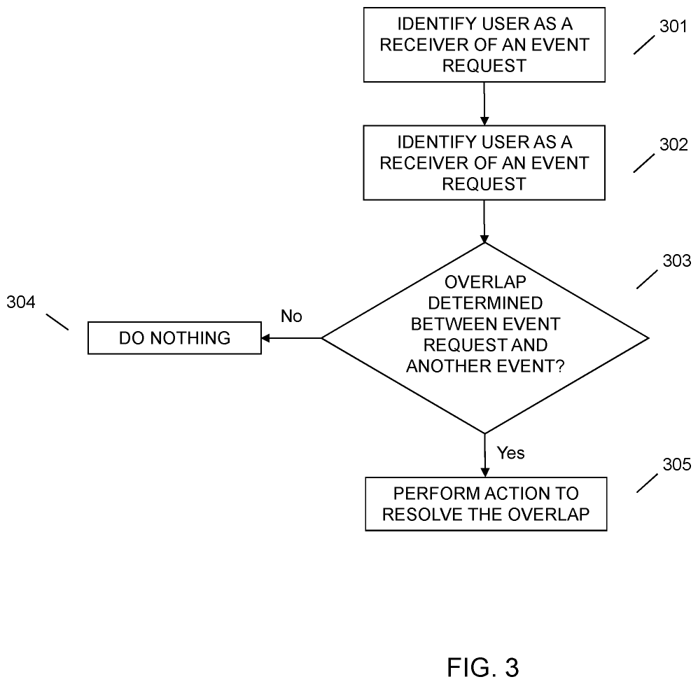

Referring now to FIG. 3, an embodiment provides a method for resolving conflicts for overlapping events from the perspective of the event receiver. At 301, an embodiment may identify a user as a receiver of an event request. In an embodiment, the event request may be created by an event requestor and may contain one or more of: a description of an event, a date of an event, a location of an event, an event recipient list, and the like. The event request may be transmitted to the user by the event requestor and may be received at a device that supports at least one email and/or calendaring application. In an embodiment, the event request may take the form of an email, a text message a social media communication, and the like. In an embodiment, identification of the user as the receiver may be facilitated by identifying that the user is listed as a member in a header of the event request. For example, the user may be listed in the “To” recipient field, the “CC” recipient field, etc.

For simplicity purposes, the remainder of this application will be described with reference to an event request that takes the form of an email communication received at an email application that supports calendaring capabilities. However, it is important to note that this designation is not limiting and that the event request may be received or detected by other means, as previously described.

At 302, an embodiment may receive an acceptance indication of the event request from the user. The acceptance indication may be a command provided by the user that directs an embodiment to accept an event request and mark an indication of an event associated with the event request on the user's calendar. The command may be provided via virtually any type of user input (e.g., touch input, voice input, gesture input, etc.) and may be received by any corresponding input detecting device (e.g., touch sensitive display, microphone, camera or video sensor, etc.). In an embodiment, the acceptance indication may be an explicit command detected after receipt of each event request. Alternatively, in another embodiment, the acceptance indication may correspond to a setting designation by the user for the system to accept all, or certain types of event requests, automatically upon their receipt.

At 303, an embodiment may determine whether an overlap exists between an event associated with the accepted event request and at least one other scheduled event. In an embodiment, the overlap may be determined by identifying and comparing the time durations designated for each relevant event. In an embodiment, the overlap may correspond to a complete overlap (i.e., where one event occurs during the entire duration of another event) or a partial overlap (e.g., where one event only coincides with a portion of another event, etc.).

Responsive to determining, at 303, that an overlap does not exist, an embodiment may, at 304, take no additional action. Conversely, responsive to determining, at 303, that an overlap does exist, an embodiment may, at 305, perform an action, as further described below, to resolve a conflict created by the overlap from the event receiver's perspective.

In an embodiment, after receiving the acceptance indication but some threshold time period prior to the start of the event, an embodiment may request the user to select one of the conflicting events to attend. To make the overlaps more apparent to the user, an embodiment may visually distinguish (e.g., via highlighting, etc.) the events that overlap with each from non-conflicting events. In an embodiment, until a decision is made, an embodiment may disable one or more other functions within the email or calendaring application. Once the user has made their selection, an indication of this decision may be automatically transmitted back to the event organizer.

In another embodiment, the system may automatically resolve an overlap conflict by dynamically selecting an event for the user to attend at the time of event acceptance. An embodiment may make this dynamic decision by identifying a priority designation associated with each event and thereafter selecting the event having the highest priority designation. The priority designations may be influenced by a number of different factors such as expressly stated importance (e.g., via the presence of a flag, a high priority indication, etc.), dynamically determined importance (e.g., determined to be related to an important project, etc.), identify of event organizer (e.g., boss, spouse, friend, etc.), nature of event (e.g., work-based event, recreational event, etc.), and the like.

In an embodiment, a communication channel between the event receiver and the event organizer may be dynamically created when an overlap is identified. Through this communication channel (e.g., an email thread, a chatroom, a text message conversation, a phone call, etc.) an event receiver may be able to directly communicate the timing issues they have with the currently scheduled event. In an embodiment, the system could use this communication channel to dynamically request a change to the meeting time. For example, an embodiment may be able to transmit a notification back to the event organizer notifying them that timing issues exist and that they would prefer to have the currently scheduled meeting at another time. An embodiment may dynamically provide the event organizer with one or more acceptable alternative event times that are compatible with the other scheduled events on the user's calendar.

In situations where partial overlaps are present, an embodiment may query the user regarding the event that they will miss a portion of. An indication of this selection may thereafter be communicated back to an event organizer of the event they will partially attend and/or the event organizer of the event that they will fully attend. Additionally or alternatively, an embodiment may dynamically select which event the user will fully attend and which event they will miss a portion of. This dynamic selection may be facilitated by determining the necessity of the user's presence during the overlapped portions of the events in question. The necessity may be determined by gauging, from available context data, the user's importance to the event during the portion. As a practical example implementation of the foregoing, a user may be scheduled to attend two meetings, where the end of Meeting A overlaps by 15 minutes with the start of Meeting B. An embodiment may dynamically choose to miss the end of Meeting A because the user is scheduled to present at the beginning of Meeting B.

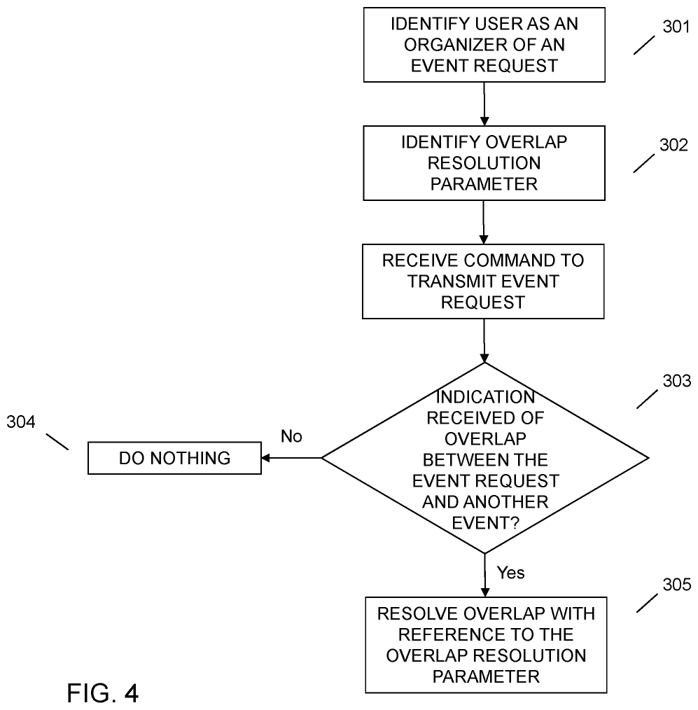

Referring now to FIG. 4, an embodiment provides a method for resolving conflicts for overlapping events from the perspective of the event organizer. At 401, an embodiment may identify a user as an organizer of an event request. In an embodiment, identification of the user as the event organizer may be facilitated by identifying that the user is listed as a member in a header of the event request. For example, the user may be listed in the “From” recipient field.

At 402, an embodiment may identify an overlap resolution parameter associated with the event request. In an embodiment, the overlap resolution parameter may correspond to a pre-emptive measure taken by the event organizer, prior to transmission of the event request, to minimize any negative effect arising from a potential event overlap. Additionally or alternatively, the overlap resolution parameter may correspond to a remedial measure, taken after transmission of the event request and upon receipt of an indication of an overlap, to minimize any negative effect resulting from the overlap.

In an embodiment, the overlap resolution parameter may correspond to an event request that is segmented into a plurality of event slices. Each of the event slices may correspond to a different portion of an event associated with the event request. In an embodiment, the organizer may require the recipient to confirm attendance for each slice that they plan, or are able to, attend. Such a requirement may help inform an organizer about the projected attendance for each event slice so that they may plan accordingly.

In an embodiment, the overlap resolution parameter may correspond to an organizer designation specifying whether overlaps need to be resolved immediately (e.g., at the time of event request receipt, etc.), some threshold time period prior the meeting (e.g., 24 hours prior to the meeting, etc.), or not resolved at all. The organizer may specify such a requirement in a settings menu associated with the email application. On the recipient's side, the organizer's designation may be prominently displayed in the event request (e.g., in larger text, in different colors, using icons, etc.) so that they may be informed of this requirement.

In an embodiment, the overlap resolution parameter may correspond to a recipient's priority with respect to the importance of their attendance at the event. Such a designation may be manually created by the organizer of the event, or, alternatively, may dynamically be determined by the system from available context data. For example, an embodiment may receive a general outline for a planned meeting, where the outline includes the identities of presenters and notable individuals. An embodiment may thereafter designate each presenter and notable individual as a high priority recipient and/or correspondingly designate all remaining recipients as passive recipients. The same concept may be applied to event slices. For example, Recipient A may be a presenter at a meeting comprising three parts. In the event request, the slice of the event during which Recipient A is presenting may be indicated to Recipient A as a high priority slice whereas the other two slices may be indicated as low priority slices (i.e., slices during which Requestor A's presence is not required).

In an embodiment, the overlap resolution parameter may correspond to an indication, received from the recipient(s), regarding the priority of their overlap. A low priority overlap may correspond to an overlap with another scheduled event where at least a portion of the other scheduled event may be missed. A high priority overlap may correspond to an overlap with another scheduled event where no portions of the other scheduled event may be missed. For example, a scheduled lunch event with friends may be considered a low priority event that may be at least partially missed by the recipient. In contrast, a meeting with the board of a company may be considered a high priority event that may not be missed by the recipient. In an embodiment, the indication of the overlap situation among all recipients may be conveyed to the organizer in a message, e.g., “8 of 10 recipients are available at this time given low priority overlaps”.

At 403, an embodiment may receive a command to transmit the event request to at least one other individual (i.e., an event recipient). Similar to the command associated with the acceptance indication described above, the command may be provided via virtually any type of user input and may be received by any corresponding input detecting device. For example, the command may be a user selection on a “send” button in the email application.

At 403, an embodiment may receive an indication that an overlap exists for the recipient between an event associated with the event request and another scheduled event. In an embodiment, the overlap may be determined on the recipient's end and an indication of the overlap may be provided to the requestor. In an embodiment, the overlap may correspond to a complete overlap or a partial overlap, as described above. Responsive to determining, at 403, that an overlap does not exist for the recipient, an embodiment may, at 404, take no additional action. Conversely, responsive to determining, at 403, that an overlap does exist, an embodiment may, at 405, resolve the overlap by reference to an overlap resolution parameter, as described above.

The various embodiments described herein thus represent a technical improvement to conventional methods of resolving conflict overlaps from the perspective of both an event organizer and an event receiver. Using the techniques described herein, embodiments of the foregoing may be able to identify and resolve overlaps before they cause issues for the event recipient, the event organizer, or a combination thereof.

As will be appreciated by one skilled in the art, various aspects may be embodied as a system, method or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, a system, apparatus, or device (e.g., an electronic, magnetic, optical, electromagnetic, infrared, or semiconductor system, apparatus, or device) or any suitable combination of the foregoing. More specific examples of a storage device/medium include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage device is not a signal and “non-transitory” includes all media except signal media.

Program code embodied on a storage medium may be transmitted using any appropriate medium, including but not limited to wireless, wireline, optical fiber cable, RF, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices and program products according to various example embodiments. It will be understood that the actions and functionality may be implemented at least in part by program instructions. These program instructions may be provided to a processor of a device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A method, comprising:
identifying, using a processor, a user as a receiver of an event request;
receiving, at an information handling device, an acceptance indication of the event request from the user;
determining, using a processor, whether an overlap exists between an event associated with the accepted event request and at least one other event; and
performing, responsive to determining that the overlap exists, an action to resolve a conflict created by the overlap.

2. The method of claim 1, wherein the determining whether the overlap exists comprises determining whether a partial overlap exists.

3. The method of claim 2, wherein the determining further comprises identifying, responsive to determining that the partial overlap exists, a portion of the event and a portion of the at least one other event corresponding to the partial overlap.

4. The method of claim 3, wherein the performing the action comprises querying the user which of the event or the at least one other event they will fully attend and thereafter providing, responsive to receiving a selection, an indication of the selection to at least the event organizer of the event the user will not fully attend.

5. The method of claim 3, wherein the performing the action comprises dynamically selecting to attend the event or the at least one other event based on a determined necessity of a presence of the user at the portion of the event and the portion of the at least one other event.

6. The method of claim 1, wherein the performing the action comprises dynamically selecting, subsequent to receiving the acceptance indication, one of the event or the at least one other event for the user to attend.

7. The method of claim 5, wherein the dynamically selecting comprises dynamically selecting by referring to a priority designation associated with the event and the at least one other event.

8. The method of claim 1, wherein the performing the action comprises visually distinguishing the event or the at least one other event on a calendar associated with the user.

9. The method of claim 1, wherein the performing the action comprises requesting an organizer of the event to adjust a time of the event to an alternative time.

10. The method of claim 1, further comprising notifying, subsequent to receiving the acceptance indication and within a threshold time period before event, the user to provide an indication regarding which of the event and the at least one other event they plan to attend.

11. A method, comprising:
identifying, using a processor, a user as an organizer of an event request;
identifying an overlap resolution parameter associated with the event request;
receiving, at an information handling device, a command to transmit the event request to at least one other individual;
receiving an indication that an overlap exists for the at least one individual between an event associated with the event request and at least one other event; and
resolving, with reference to the overlap resolution parameter, the overlap.

12. The method of claim 11, wherein the overlap resolution parameter corresponds to an attendance confirmation request for a plurality of event slices for the event request.

13. The method of claim 12, wherein the resolving comprises identifying an attendance response from a recipient of the event request to the attendance confirmation request for each of the plurality of event slices.

14. The method of claim 11, wherein the overlap resolution parameter corresponds to a designated temporal acceptance threshold for the event request.

15. The method of claim 11, wherein the overlap resolution parameter corresponds to a priority of a recipient of the event request with respect to an importance of their attendance at the event.

16. The method of claim 15, wherein the resolving the overlap comprises designated the user as one of: a high priority recipient or a low priority recipient.

17. The method of claim 11, wherein the overlap resolution parameter corresponds to an indication regarding the priority of the overlap.

18. The method of claim 16, wherein when the indication reveals a low priority overlap, the overlap may be resolved in favor of the event.

19. The method of claim 16, wherein when the indication reveals a high priority overlap, the overlap may be resolved in favor of the event.

20. An information handling device, comprising:
a processor;
a memory device that stores instructions executable by the processor to:
identify a user as a receiver of an event request;
receive an acceptance indication of the event request from the user;
determine whether an overlap exists between an event associated with the accepted event request and at least one other event; and
perform, responsive to determining that the overlap exists, an action to resolve a conflict created by the overlap.
